(19) United States
(12) Patent Application Publication
(10) Pub. No.: US 2020/0339046 A1
(43) Pub. Date: Oct. 29, 2020

(54) CURRENT-CARRYING CABLE

(71) Applicant: TOYOTA JIDOSHA KABUSHIKI KAISHA, Toyota-shi (JP)

(72) Inventor: Hiroshi INANO, Miyoshi-shi (JP)

(73) Assignee: TOYOTA JIDOSHA KABUSHIKI KAISHA, Toyota-shi (JP)

(21) Appl. No.: 16/830,390

(22) Filed: Mar. 26, 2020

(30) Foreign Application Priority Data
Apr. 23, 2019 (JP) 2019-082352

(51) Int. Cl. B60R 16/02; H01B 7/00

(52) U.S. Cl. CPC B60R 16/0215; H01B 7/0045

(57) ABSTRACT

A current-carrying cable includes a plurality of electric wires inserted inside a cylindrical shield portion. A cross section perpendicular to a longitudinal direction of the shield portion has a star shape provided with plurality of recesses and projections consecutive in a circumferential direction.

This application claims priority from Japanese Patent Application No. 2019-082352 filed on Apr. 23, 2019, the disclosure of which is incorporated herein by reference in its entirety.

### FIELD OF THE ART

The present invention relates to a current-carrying cable, particularly to a current-carrying cable formed by inserting a plurality of electric wires through the inside of a cylindrical shield portion.

### BACKGROUND ART

A current-carrying cable formed by inserting a plurality of electric wires through the inside of a cylindrical shield portion is known. The current-carrying cable (wire harness) described in Patent Document 1 is an example thereof, and the cable is disposed, for example, between an inverter and an electric motor, and subjected to application of a steep pulse voltage. This current-carrying cable described in Patent Document 1 includes a metal layer provided on a surface of a bellows-shaped synthetic resin tube, and the metal layer functions as a shield portion. By using the bellows-shaped synthetic resin tube, flexibility of the current-carrying cable becomes high and wiring (arrangement) becomes easy.

### PRIOR ART DOCUMENT

### Patent Document

[PATENT DOCUMENT 1] Japan Patent Publication No. 2012-84435

### SUMMARY OF THE INVENTION

### Problem to be Solved by the Invention

When a steep pulse voltage is applied to the current-carrying cable as described in Patent Document 1, LC (inductance and capacitance) is generated in the internal electric wires, however, as the cable length becomes long, the LC increases and an electrical resonance frequency decreases, and an overlapped region (E region in FIG. 3) with a frequency component of the steep pulse voltage becomes larger and a surge voltage may be generated due to electrical resonance, and an overvoltage may be applied to an electrical component such as the electric motor.

The “inverter waveform frequency component A” in FIG. 3 is a frequency component of an inverter output voltage when a steep pulse voltage is applied from the inverter to the electric motor, and overlaps a resonance frequency in the E region at a high-frequency side, that is, a side at which switching characteristics are high in speed and a rotation speed of the electric motor becomes high, and a surge voltage may be generated. The “cable (long) resonance frequency” is a resonance frequency characteristic when the cable length is long, and the “cable (short) resonance frequency” is a resonance frequency characteristic when the cable length is short, and as the cable length becomes long, the resonance frequency becomes low.

The present invention was made in view of the above-described circumstances, and an object thereof is to suppress a decrease in the resonance frequency of electric wires and generation of a surge voltage when the current-supplying cable is made longer.

### Solution to Problem

To achieve the above object, a first aspect of the present invention provides a current-carrying cable including a plurality of electric wires inserted inside a cylindrical shield portion, wherein a cross section perpendicular to a longitudinal direction of the shield portion has a star shape provided with plurality of recesses and projections consecutive in a circumferential direction.

A second aspect of the present invention provides the current-carrying cable recited in the first aspect of the invention, wherein the shield portion is a shield pipe made of a conductive metal material.

A third aspect of the present invention provides the current-carrying cable recited in the first or second aspect of the invention, wherein the cross section of the shield portion includes 15 to 50 sets of recesses and projections around a circumference thereof.

A fourth aspect of the present invention provides the current-carrying cable recited in any one of the first to third aspects of the invention, wherein the current-carrying cable is disposed between an electric motor used as a drive power source for a vehicle and an inverter, and carries a steep pulse voltage output from the inverter to the electric motor.

### Advantageous Effects of Invention

In the current-carrying cable, the shield portion has a star-shaped cross section, so that the shield pipe is brought into intermittent contact with outer circumferential surfaces of the electric wires provided inside, in the circumferential direction, and an average separation distance between conductors of the electric wires and the shield portion becomes longer, and in inverse proportion to the separation distance, C (capacitance) becomes smaller. Accordingly, LC to be generated in the electric wires when the steep pulse voltage is applied is reduced and the resonance frequency becomes higher, so that even when the cable length becomes longer and the resonance frequency becomes lower, the overlap with the frequency component of the steep pulse voltage is suppressed or the overlapped region becomes smaller, and generation of a surge voltage caused by electric resonance is suppressed.

In the second aspect of the invention, the shield portion is a metal shield pipe, and is therefore difficult to elastically deform, and the LC can be reduced by properly maintaining a distance with the internal electric wires, and the resonance frequency can be made high to suppress generation of a surge voltage. That is, when a shield portion (metal layer) is provided on a surface of a synthetic resin tube as described in Patent Document 1 above, for example, a shield portion having a star-shaped cross section can be provided by shaping the surface of the synthetic resin tube into a star shape and by plating or vapor deposition, etc., however, a distance between the shield portion and the electric wires may change due to elastic deformation of the synthetic resin tube, and the effect of reducing the LC of the electric wires may not be stably obtained.

Since the cross section of the shield portion includes 15 to 50 sets of recesses and projections in the third aspect of the invention, the shield pipe is brought into contact at intervals with the outer circumferential surfaces of the plurality of electric wires provided inside the shield pipe, and a predetermined average separation distance between the shield pipe and the electrical wires is properly maintained, and an effect of reducing the C (capacitance) can be stably obtained. That is, although this may depend on the diameter and the number of electric wires of the shield portion, if the number of sets of recesses and projections is less than 15, the number of contacts of the shield portion with the electric wires becomes small and a contact state becomes unstable, and the average separation distance may vary. If the number of sets of recesses and projections is more than 50, the number of contacts with the electric wires becomes large, and the effect of reducing the C (capacitance) may not be properly obtained.

The fourth aspect of the invention relates to the current-carrying cable to be disposed between the electric motor used as the drive power source for a vehicle and the inverter, and a high steep pulse voltage corresponding to a required torque is applied to the electric motor, so that the effect of the present invention of preventing application of an overvoltage to the electric motor by suppressing generation of a surge voltage due to reducing the LC of the electric wires can be properly obtained.

### BRIEF DESCRIPTION OF DRAWINGS

FIG. 1 is a schematic view describing an example in a case where the present invention is applied to a current-carrying cable that connects a motor generator (MG) used as a drive power source and an inverter.

FIG. 2 is a sectional view taken along a chained line in a direction of arrows II in FIG. 1, that is, a sectional view of the current-carrying cable cut perpendicularly to a longitudinal direction thereof.

FIG. 3 is a diagram illustrating a relationship between a resonance frequency of electric wires included in the current-carrying cable shown in FIG. 1, and a frequency component of an inverter output voltage.

FIG. 4 is a view describing another example of the present invention, and is a sectional view of the current-carrying cable, corresponding to FIG. 2.

FIG. 5 is a view describing still another example of the present invention, and is a sectional view of the current-carrying cable, corresponding to FIG. 2.

### MODES FOR CARRYING OUT THE INVENTION

A current-carrying cable of the present invention is disposed, for example, between an electric motor used as a drive power source for vehicle and an inverter, however, the cable may be disposed between an electric generator and an inverter installed in a vehicle. The current-carrying cable can be used as a current-carrying cable for various electrical components for vehicles or for other than vehicles, and its purpose is not limited. As the electric motor, an induction type or synchronous-type AC motor is properly used, however, the electric motor may be other AC motors, or may be a motor generator that selectively functions as either one of an electric motor and an electric generator.

Recesses and projections in the star-shaped cross section of the shield portion may be provided parallel to a longitudinal direction thereof, or may be twisted at a predetermined twist angle. The twist angle is appropriately, for example, about 30° or less. The star shape of the cross section of the shield portion is provided as, for example, a star-shaped cylindrical shape with a constant size, that is, a constant diameter across the entire length in the longitudinal direction of the shield portion, and it is also possible that the diameter changes periodically in the longitudinal direction like bellows. The cross section of the shield portion includes 15 to 50 sets of recesses and projections around a circumference thereof, but may include less than 15 sets of recesses and projections or more than 50, depending on the diameter or the number of electric wires of the shield portion. It is desirable that the present invention is applied to the entire length of an elongated current-carrying cable so that the cable has a star-shaped cross section across the entire length of the shield portion, however, the present invention may be applied to only a portion of the current-carrying cable so that the cable partially has a simple cylindrical shape or has a bellows shape by changing the diameter periodically in the longitudinal direction.

As the cylindrical shield portion, a shield pipe entirely made of a conductive metal material is appropriately used, however, a synthetic resin pipe having a star-shaped inner circumferential surface or outer circumferential surface and provided with a conductive metal layer by plating, vapor deposition, application, or the like, may also be used. A metal foil, a metal thread braid, or the like may be bonded to a synthetic resin pipe. A metal shield pipe may have various forms such that the metal shield pipe is formed by rolling a corrugated member provided with a large number of consecutive recesses and projections into a cylindrical shape and joining by welding, etc., or molding a metal pipe into a star shape by extrusion or drawing process. Desirably, the shield pipe has flexibility and bendability, and can be bent and deformed according to a routing path together with a plurality of electric wires inserted through the inside of the shield pipe, however, the shield pipe may not be deformable in normal use. The shield pipe may have a straight form, or have a bent portion or the like in advance at a middle portion.

When a shield pipe is used as the shield portion, it is desirable that a protective coating made of an insulating material such as a synthetic resin is provided on an outer circumference side of the shield pipe. The outer circumferential surface of the protective coating may be a simple cylindrical surface, or to secure flexibility of the current-carrying cable, bellows-shaped or spiral recesses and projections may be provided. Such a protective coating is provided integrally on the outer circumference side of the shield pipe by, for example, insert molding, or may be fixed to the outer circumference side by an adhesive agent, etc. In a case where the synthetic resin pipe is formed to have a star-shaped cross section, and a shield portion is provided on an inner circumferential surface, this synthetic resin pipe itself can be used as a protective coating.

The plurality of electric wires disposed inside the shield portion may be two in number, or may be three or more in number. As the electric wire, for example, a conductor made of a conductive metal layer such as copper or aluminum and coated with an insulation coating of a synthetic resin, etc., is appropriately used. The conductor may be variously formed in such away that the conductor maybe formed as a twisted wire by twisting a large number of thin wire materials or may be formed of a single wire material.

### EXAMPLE

Hereinafter, an example of the present invention is described in detail with reference to the drawings. In the following example, the drawings are simplified or deformed as appropriate for description, and thus the ratios of dimensions, the shapes and the like of respective portions are not always accurately drawn.

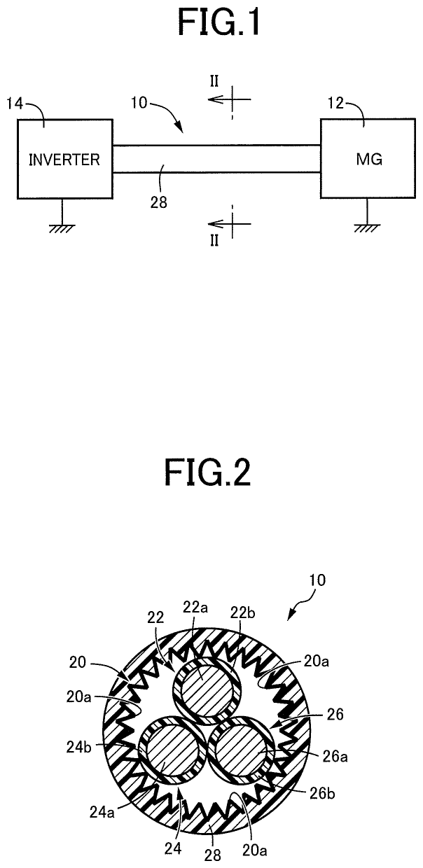

FIG. 1 is a schematic view describing a current-carrying cable 10 as an example of the present invention, and this current-carrying cable 10 is disposed between a motor generator (MG) 12 used as a drive power source for vehicle and an inverter 14. The motor generator 12 is selectively used as an electric motor and an electric generator, and is used as an electric motor to function as a drive power source of a vehicle by being subjected to application of a steep pulse voltage from the inverter 14 through the current-carrying cable 10. In addition, during coasting of the vehicle, the motor generator is also used as an electric generator by being regenerative-controlled, and a generated steep pulse voltage is applied to the inverter 14 through the current-carrying cable 10 to charge an electric storage device such as a battery through the inverter 14.

FIG. 2 is a sectional view taken along a chained line in a direction of arrows II in FIG. 1, that is, a sectional view of the current-carrying cable 10 cut perpendicularly to a longitudinal direction thereof. As is clear from the sectional view in FIG. 2, the current-carrying cable 10 includes a cylindrical shield pipe 20, three electric wires 22, 24, and 26 inserted through the inside of the shield pipe 20, and a cylindrical protective coating 28 integrally fixed to the outer circumference side of the shield pipe 20. The motor generator 12 is a permanent-magnet synchronous type for three-phase AC, and through the three electric wires 22, 24, and 26 of the current-carrying cable 10, a steep pulse voltage of three phases of the U phase, the V phase, and the W phase offset by 120° is applied by the inverter 14. The three electric wires 22, 24, and 26 respectively include conductors 22a, 24a, and 26a made of a conductive metal layer such as copper or aluminum, and insulation coatings 22b, 24b, and 26b made of a synthetic resin or the like coating the conductors 22a, 24a, and 26a. Each of the conductors 22a, 24a, and 26a is a twisted wire formed of a large number of thin wire materials twisted, or a comparatively thick single wire material.

The shield pipe 20 is formed by rolling a conductive corrugated metal plate member into a cylindrical shape around a center line and joining the rolled plate member by welding, etc. The corrugated metal plate member is made of stainless steel or aluminum, etc., and provided with plurality of consecutive recesses and projections parallel to each other by pressing or roll processing. The center line is parallel to the recesses and projections of the corrugation. A cross section (FIG. 2) perpendicular to the longitudinal direction has a star shape provided with plurality of consecutive recesses and projections in a circumferential direction thereof. The shield pipe 20 has a diameter that is substantially constant across the entire length in the longitudinal direction, and the large number of recesses and projections are provided parallel to the longitudinal direction, and the star-shaped cross section has substantially the same size across the entire length of the shield pipe 20. This shield pipe 20 has a straight shape, but has slight flexibility and bendability, and can be bent and deformed according to a wiring path together with the electric wires 22, 24, and 26 inserted therethrough. The shield pipe 20 may be provided with one or a plurality of bent portions or folded portions in advance as necessary. The large number of recesses and projections do not necessarily have to be parallel to the longitudinal direction of the shield pipe 20, and maybe twisted at a predetermined twist angle of, for example, about 30° or less.

The shield pipe 20 corresponds to the shield portion both ends of which in the longitudinal direction are respectively grounded via a case of the motor generator 12 and a case of the inverter 14. As shown in FIG. 2, the shield pipe 20 is circumscribed to the outer circumferential surfaces of the three electric wires 22, 24, and 26 and the electric wires 22, 24, and 26 are positioned in a positional relationship in which centers of the three electric wires 22, 24, and 26 are vertices of an equilateral triangle and the outer circumferential surfaces of the three electric wires 22, 24, and 26 are in contact with each other. The shield pipe 20 has a star-shaped cross section, so that tip ends of inward projecting portions 20a projecting to the inner circumference side are brought into contact at intervals with the outer circumferential surfaces of the respective electric wires 22, 24, and 26, and the contact areas between the respective electric wires 22, 24, and 26 and the shield pipe 20 become relatively small. Accordingly, an average separation distance between the conductors 22a, 24a, and 26a of the respective electric wires 22, 24, and 26 and the shield pipe 20 becomes larger than that in a case where the shield pipe has no recesses and projections in the circumferential direction, and in inverse proportion to the separation distance, C (capacitance) between the conductors 22a, 24a, and 26a becomes smaller. The number of sets of recesses and projections in the star shape is appropriately in a range of 15 to 50 around the entire circumference, and in the present example, 30 sets are provided, and each of the recesses and projections has a steep triangular shape, and as shown in FIG. 2, tip ends of only one or two of the inward projecting portions 20a are brought into contact with the outer circumferential surface of each electric wire 22, 24, 26, and therefore, the average separation distance to the conductors 22a, 24a, and 26a can be properly secured. The number of contacts between the inward projecting portions 20a of the shield pipe 20 and each electric wire 22, 24, 26 may be three or more as intermittent contacts by, for example, elastic deformation of the insulation coatings 22b, 24b, and 26b of the electric wires 22, 24, and 26.

The protective coating 28 is made of an insulating synthetic resin, and is integrally molded with by insert molding and integrally fixed to the outer circumference side of the shield pipe 20 having a star-shaped cross section. An outer circumferential surface of the protective coating 28 may be a simple cylindrical surface with a constant diameter, however, to secure bendability of the current-carrying cable 10, a bellows-shaped or spiral corrugation (recesses and projections) is provided as necessary.

Here, in the current-carrying cable 10, when a steep pulse voltage (inverter output voltage) is applied from the inverter 14, LC (inductance and capacitance) is generated in the electric wires 22, 24, and 26 inside the shield pipe 20, and as the cable 10 becomes longer in length and the LC increases, the electrical resonance frequency of the electric wires 22, 24, and 26 is lowered. Therefore, an overlap occurs with a frequency component of the inverter output voltage, and a surge voltage may be generated due to electrical resonance and an overvoltage may be applied to the motor generator 12.

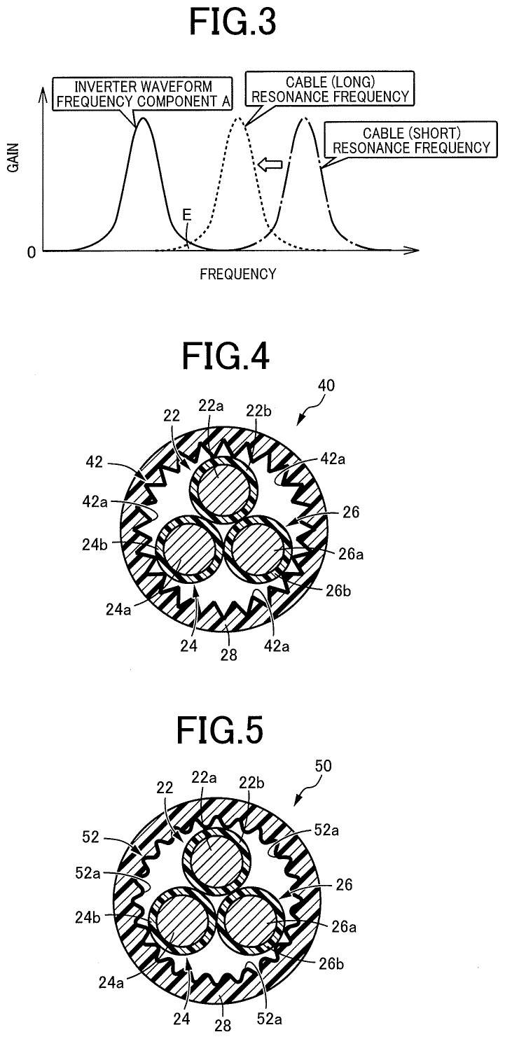

Describing in detail with reference to FIG. 3, the “inverter waveform frequency component A” in FIG. 3 is a frequency component of the inverter output voltage (steep pulse voltage) when a steep pulse voltage is applied to the motor generator 12 from the inverter 14, and the gain of the “inverter waveform frequency component A” is a gain of each frequency component included in the steep pulse voltage waveform. As a switching characteristics of an inverter device becomes higher in speed, the frequency component in the inverter output voltage becomes higher. The “cable (long) resonance frequency” is resonance frequency characteristics of the electric wires 22, 24, and 26 when the cable length is relatively long, and the “cable (short) resonance frequency” is resonance frequency characteristics of the electric wires 22, 24, and 26 when the cable length is relatively short, and gains in the resonance frequency characteristics represent resonance intensities respectively. As the cable length of the current-carrying cable 10 becomes longer depending on installation conditions of the motor generator 12 and the inverter 14 in the vehicle, the LC of the electric wires 22, 24, and 26 increases and the resonance frequency becomes lower, and the overlapped region E with the frequency component A of the inverter output voltage becomes larger. In this overlapped region E, the steep pulse voltage generated by high-speed switching of the inverter 14 may electrically resonate due to the LC of the current-carrying cable 10, and a surge voltage may be generated.

On the other hand, in the current-carrying cable 10 of the present example, the shield pipe 20 has a star-shaped cross section, so that the shield pipe 20 is brought into intermittent contact with the outer circumferential surfaces of the electric wires 22, 24, and 26 provided inside, in the circumferential direction, and the average separation distance between the conductors 22a, 24a, and 26a of the electric wires 22, 24, and 26 and the shield pipe 20 becomes longer, and in inverse proportion to the separation distance, the C (capacitance) becomes smaller. Accordingly, the LC to be generated in the electric wires 22, 24, and 26 when the inverter output voltage is applied is reduced and the resonance frequency becomes higher, so that even when the cable length becomes longer and the resonance frequency becomes lower, the overlap with the frequency component A of the inverter output voltage is suppressed or the overlapped region E becomes smaller, and generation of a surge voltage caused by electric resonance is suppressed, and application of an overvoltage to the motor generator 12 caused by the surge voltage is suppressed.

In addition, since the shield pipe 20 made of metal is provided as the shield portion, it is difficult to elastically deform as compared with a case where the shield portion is provided on a synthetic resin tube, so that a distance relationship between the shield pipe 20 and the electric wires 22, 24, and 26 provided inside the shield pipe 20 can be properly maintained so as to reduce the LC, and the resonance frequency can be made higher to suppress generation of a surge voltage.

Since the number of sets of recesses and projections in the star-shaped cross section of the shield pipe 20 is in a range of 15 to 50, the shield pipe 20 is brought into contact at intervals with the outer circumferential surfaces of the electric wires 22, 24, and 26 provided inside the shield pipe 20, and a predetermined average separation distance between the shield pipe 20 and the electrical wires 22, 24, and 26 is properly maintained, and an effect of reducing the C (capacitance) can be stably obtained. That is, if the number of sets of recesses and projections is less than 15, the number of contacts between the shield pipe 20 and the electric wires 22, 24, and 26 becomes small and state of contact becomes unstable, and the average separation distance may vary. If the number of sets of recesses and projections is more than 50, the number of contacts with the electric wires 22, 24, and 26 becomes large, and the effect of reducing the C (capacitance) may not be properly obtained.

The present example relates to the current-carrying cable 10 to be disposed between the motor generator 12 used as the drive power source for vehicle and the inverter 14, and a high inverter output voltage corresponding to a required torque is applied to the motor generator 12, so that the effect of preventing application of an overvoltage to the motor generator 12 by suppressing generation of a surge voltage due to reducing the LC of the electric wires 22, 24, and 26 can be properly obtained.

In the current-carrying cable 10 including the three electric wires 22, 24, and 26, the shield pipe 20 is circumscribed to the outer circumferential surfaces of the three electric wires 22, 24, and 26 so that the electric wires 22, 24, and 26 are positioned in the positional relationship in which centers of the three electric wires 22, 24, and 26 are vertices of an equilateral triangle and the outer circumferential surfaces of the three electric wires 22, 24, and 26 are in contact with each other. Accordingly, the positional relationship between the three electric wires 22, 24, and 26 and the shield pipe 20 is properly maintained and positional displacements are suppressed, electrical characteristics such as the LC of the three electric wires 22, 24, and 26 are stabilized, and an effect of suppressing generation of a surge voltage can be stably obtained.

The star shape of the cross section of the shield pipe 20 has a constant size across the entire length in the longitudinal direction of the shield pipe 20, so that the distance relationship between the electric wires 22, 24, and 26 and the shield pipe 20 is substantially constant across the entire length, and even when the current-carrying cable 10 is bent for wiring, the electrical characteristics such as the LC of the electric wires 22, 24, and 26 change less, and an effect of suppressing generation of the surge voltage can be stably obtained. That is, when a bellows-shaped shield portion is employed as described in Patent Document 1 above, an average separation distance between the shield pipe 20 and the electric wires 22, 24 and 26 changes due to bending and expansion and contraction of the shield portion, and an effect of reducing the LC of the electric wires 22, 24, and 26 may not be stably obtained. For example, when the shield portion is stretched, the bellows is stretched and its recesses and projections become smaller, so that the average separation distance becomes shorter.

Next, another example of the present invention is described. In the following example, a portion substantially in common with the example described above is provided with the same reference sign, and detailed description thereof is omitted.

FIG. 4 is a view corresponding to FIG. 2, and is a sectional view of a current-carrying cable 40. In this current-carrying cable 40, the 24 sets of recesses and projections are provided in a star shape of a shield pipe 42, which are smaller than those in the example described above. Tip ends of one or two inward projecting portions 42a are brought into contact with the outer circumferential surface of each electric wire 22, 24, 26, and accordingly, the electric wires 22, 24, and 26 are properly positioned, and an average separation distance between the shield pipe 20 and conductors 22a, 24a, and 26a of the electric wires 22, 24, and 26 can be properly secured. This number of sets of recesses and projections in the star-shaped cross section can be changed as appropriate.

FIG. 5 is a view corresponding to FIG. 2, and is a sectional view of a current-carrying cable 50. This current-carrying cable 50 has recesses and projections of a star-shape of a shield pipe 52 which are different from those of the current-carrying cable 40 shown in FIG. 4. That is, tip ends of the projections and bottoms of the recesses are rounded to have smoothly corrugated arc shapes, and biting of inward projecting portions 52a into outer circumferential surfaces of the insulation coatings 22b, 24b, and 26b of the electric wires 22, 24, and 26 is suppressed, and separation distances to the conductors 22a, 24a, and 26a can be properly secured. Instead of rounding of the tip ends and bottoms of the projections and recesses into arc shapes, flat surfaces may be provided at the tip ends of the projections. Alternatively, only the tip ends of the inward projecting portions 52a projecting to the inner circumference side may be rounded or formed into flat surfaces. In the shield pipe 20 shown in FIG. 2 which includes larger number of recesses and projections, the tip ends of the projections and the bottoms of the recesses can be rounded as in the shield pipe 52 or formed to have flat surfaces in the same manner.

In the current-carrying cables 10, 40, and 50 of the respective examples described above, it is also possible that a protective coating 28 whose inner circumferential surface has a star-shaped cross section is manufactured by injection molding, etc., separately from the shield pipes 20, 42, and 52, and a conductive metal layer is fixed by plating, vapor deposition, application, or bonding, etc., onto the inner circumferential surface having the star-shaped cross section of the protective coating 28 to forma shield portion as described in Patent Document 1 above. In other words, each of the shield pipes 20, 42, and 52 may be a shield portion of a metal layer provided on the inner circumferential surface of the protective coating 28 by plating, vapor deposition, application, or bonding, etc.

While examples of the present invention are described above in detail based on the drawings, these are only of an embodiment, and the present invention can be carried out in variously changed or improved forms based on knowledge of a person skilled in the art.

### REFERENCE SIGNS LIST

10, 40, 50: current-carrying cable 12: motor generator (electric motor) 14: inverter 20, 42, 52: shield pipe (shield portion) 22, 24, 26: electric wire

What is claimed is:

1. A current-carrying cable including a plurality of electric wires inserted inside a cylindrical shield portion, wherein a cross section perpendicular to a longitudinal direction of the shield portion has a star shape provided with plurality of recesses and projections consecutive in a circumferential direction.

2. The current-carrying cable according to claim 1, wherein the shield portion is a shield pipe made of a conductive metal material.

3. The current-carrying cable according to claim 1, wherein the cross section of the shield portion includes 15 to 50 sets of recesses and projections around a circumference thereof.

4. The current-carrying cable according to claim 2, wherein the cross section of the shield portion includes 15 to 50 sets of recesses and projections around a circumference thereof.

5. The current-carrying cable according to claim 1, wherein the current-carrying cable is disposed between an electric motor used as a drive power source for a vehicle and an inverter, and carries a steep pulse voltage output from the inverter to the electric motor.

6. The current-carrying cable according to claim 2, wherein the current-carrying cable is disposed between an electric motor used as a drive power source for a vehicle and an inverter, and carries a steep pulse voltage output from the inverter to the electric motor.

7. The current-carrying cable according to claim 3, wherein the current-carrying cable is disposed between an electric motor used as a drive power source for a vehicle and an inverter, and carries a steep pulse voltage output from the inverter to the electric motor.

8. The current-carrying cable according to claim 4, wherein the current-carrying cable is disposed between an electric motor used as a drive power source for a vehicle and an inverter, and carries a steep pulse voltage output from the inverter to the electric motor.
